(19) United States
(12) Patent Application Publication
(10) Pub. No.: US 2011/0124224 A1
(43) Pub. Date: May 26, 2011

(54) ELECTRICAL CARD CONNECTOR WITH STABILIZED CONTACT TAILS

(75) Inventor: JING-JIE GUO, Shenzhen (CN)

(73) Assignee: HON HAI PRECISION INDUSTRY CO., LTD., Tu-Cheng (TW)

(21) Appl. No.: 12/951,101

(22) Filed: Nov. 22, 2010

(30) Foreign Application Priority Data
Nov. 20, 2009 (CN) 200920315320.0
Nov. 25, 2009 (CN) 200920315743.2
Nov. 25, 2009 (CN) 200920315772.9

(51) Int. Cl. H01R 13/648; H01R 24/00

(52) U.S. Cl. 439/607.01; 439/629

(57) ABSTRACT

An electrical card connector (100) includes an insulative housing (1), a number of contacts (2) assembled to the insulative housing from a bottom of the insulative housing, and a retaining plate (3) attached to the insulative housing. The insulative housing defines a number of passageways (101) and a number of slits (103) extending along a mating direction. Each contact includes a base portion (20) received in the passageway, a contact portion (21) extending beyond the insulative housing, a connecting portion (22) extending below the insulative housing in a vertical direction perpendicular to the mating direction, and a pair of wing portions (24) retained in the slits. The retaining plate includes a number of cutouts (33) retaining the connecting portions of the contacts from moving in a lengthwise direction orthogonal to the mating direction and the vertical direction. One of the insulative housing and the retaining plate defines a bottommost surface and the connecting portions of the contacts extend up to the bottommost surface.

### BACKGROUND OF THE INVENTION

1. Field of the Invention

The present invention relates generally to an electrical card connector, and more particularly to an electrical card connector that prevents deflecting of its long contact tail portions.

2. Description of Related Arts

SIM (Subscriber Identity Module) card connectors are widely used in mobile phones for identification. A traditional SIM card connector usually comprises an insulative housing, a plurality of contacts received in the insulative housing, and a shield covering the insulative housing, defining a receiving room therebetween for receiving an inserted card. The insulative housing defines an upper surface coupling with the card and a lower surface opposite to the upper surface for mounting to a printed circuit board. Each contact comprises a base portion retaining in the insulative housing, a contacting portion curvedly extending beyond the upper surface of the insulative housing for mating with the card, a soldering portion extending out of the insulative housing and coplanar with the lower surface to be connected with the printed circuit board, and a connecting portion between the base portion and the soldering portion. The connecting portion extends downwardly from the base portion in a vertical direction. In order to meet with different requirements of customers, the insulative housing of the SIM card connector increases in height for saving spaces for other circuits on the printed circuit board or etc. Therefore, the connecting portion of the contact is lengthened according to the increased height of insulative housing. The connecting portions of the contact are prone to be deflected away from right position. Soldering portions of the contacts are difficult to be coplanar because of the deflected contacting portions, and the SIM card connector is difficultly soldered with the printed circuit board firmly.

Hence, an electrical card connector preventing deflecting of the long contact tail portions is desired to overcome the aforementioned disadvantage of the prior art.

### SUMMARY OF THE INVENTION

Accordingly, an object of the present invention is to provide an electrical card connector preventing deflecting of the long contact tail portions.

To achieve the above object, an electrical card connector includes an insulative housing, a number of contacts assembled to the insulative housing from a bottom of the insulative housing, and a retaining plate attached to the insulative housing. The insulative housing defines a number of passageways and a number of slits extending along a mating direction. Each contact includes a base portion received in the passageway, a contact portion extending beyond the insulative housing, a connecting portion extending below the insulative housing in a vertical direction perpendicular to the mating direction, and a pair of wing portions retained in the slits. The retaining plate includes a number of cutouts retaining the connecting portions of the contacts from moving in a lengthwise direction orthogonal to the mating direction and the vertical direction. One of the insulative housing and the retaining plate defines a bottommost surface and the connecting portions of the contacts extend up to the bottommost surface.

Other objects, advantages and novel features of the invention will become more apparent from the following detailed description when taken in conjunction with the accompanying drawings.

### BRIEF DESCRIPTION OF THE DRAWINGS

FIG. 1 is a perspective, assembled view of an electrical card connector in a first embodiment in accordance with the present invention;

FIG. 2 is a perspective, exploded view of the electrical card connector of FIG. 1;

FIG. 3 is another perspective, assembled view of the electrical card connector similar to FIG. 1, but taken from a different aspect;

FIG. 4 is another perspective, exploded view of the electrical connector similar to FIG. 2, but taken from a different aspect;

FIG. 5 is a perspective, assembled view of the electrical card connector in a second embodiment of the present invention;

FIG. 6 is a perspective, exploded view of the electrical card connector of FIG. 5; and

FIG. 7 is another perspective, assembled view of the electrical card connector similar to FIG. 6, but taken from a different aspect.

### DETAILED DESCRIPTION OF THE PREFERRED EMBODIMENT

Reference will now be made in detail to the preferred two embodiments of the present invention.

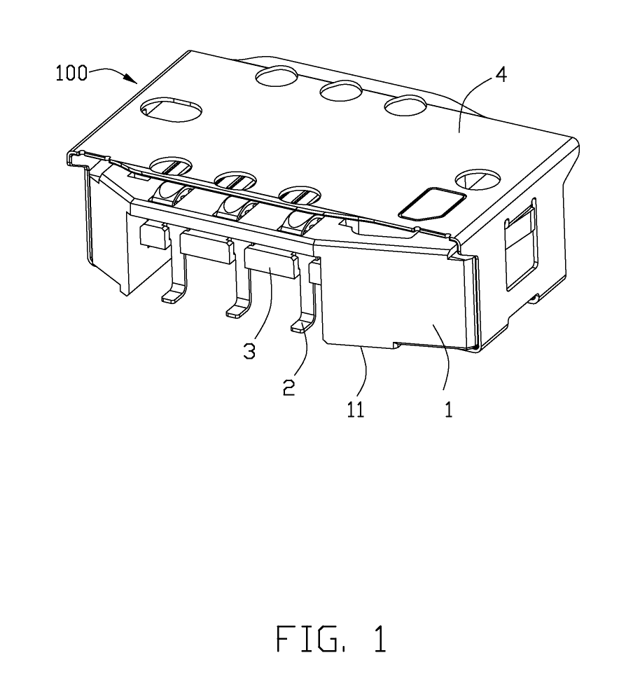

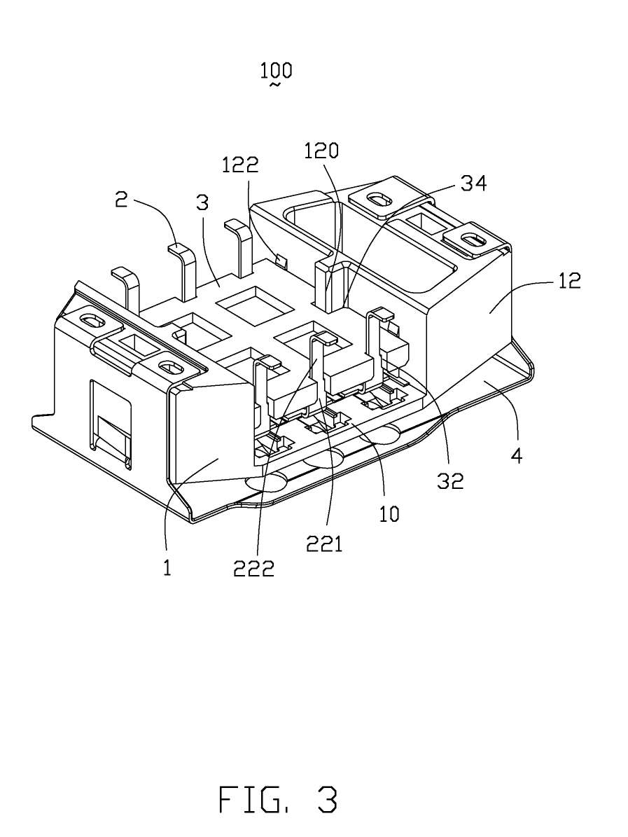

Referring to FIGS. 1-4, an electrical card connector 100 in accordance with the present invention in a first embodiment, comprises an insulative housing 1, a plurality of contacts 2 retained in the insulative housing 1, a retaining plate 3 attached to the insulative housing 1 and retaining with the contacts 2 for preventing the contacts 2 from shaking leftward and rightward, and a metal cover 4 shielding over the insulative housing 1 for defining a card receiving room (not labeled) therebetween.

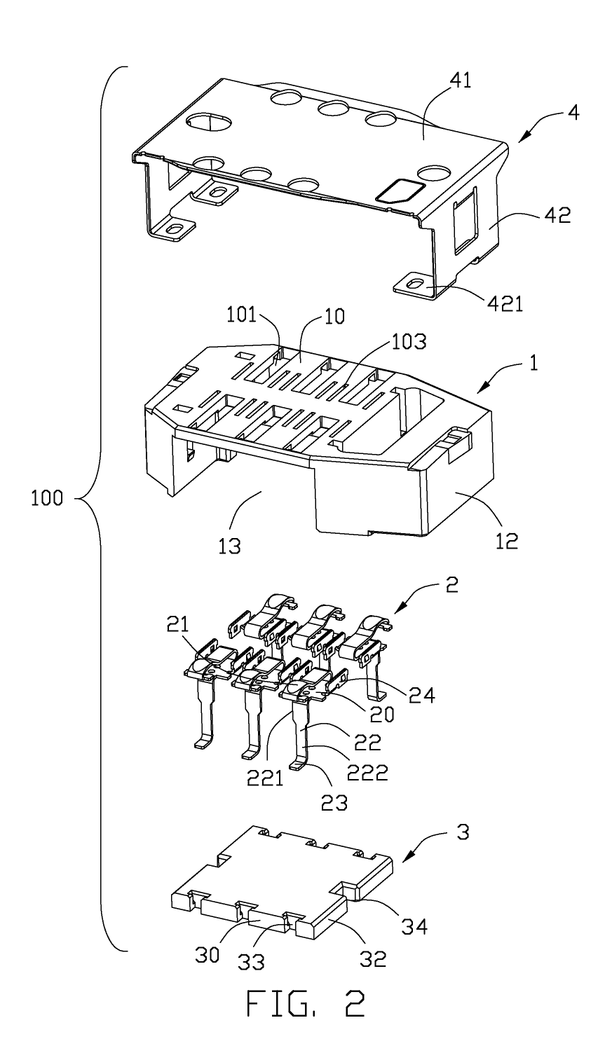

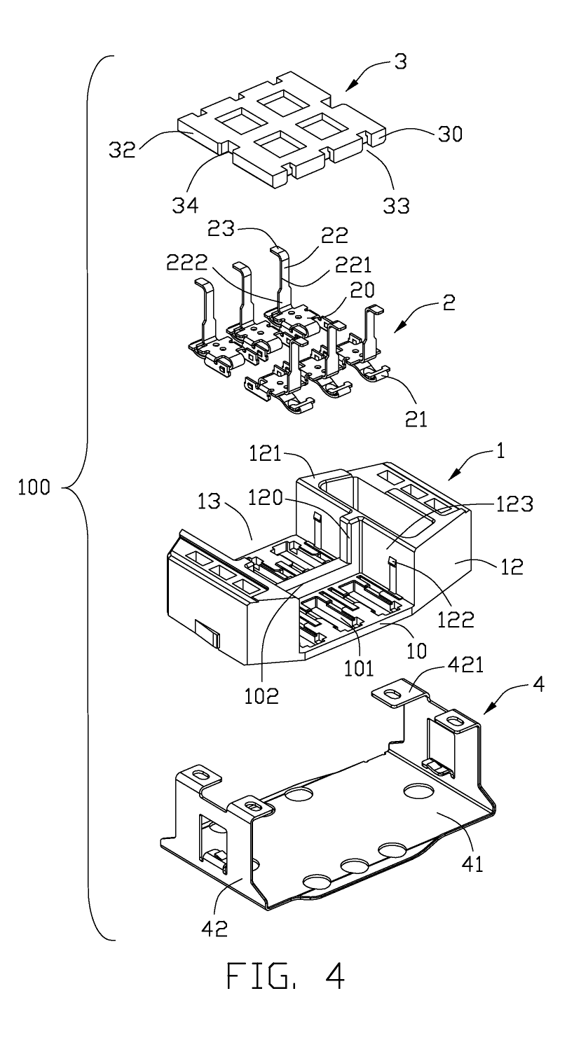

Referring to FIGS. 2 and 4, the insulative housing 1 comprises a main portion 10 and a pair of vertical walls 12 extending downwardly from two opposite edges of the main portion 10. The vertical walls 12 and the main portion 10 cooperatively define a receiving space 13 therebetween. The receiving space 13 is located below the card receiving room and separates from each other via the main portion 10. The main portion 10 defines a plurality of passageways 101 and a pair of slits 103 besides each passageway 101. The passageways 101 extend along a mating direction along which an inserted card is inserted. The passageways 101 are positioned at two rows along the mating direction with each passageway 101 at the front row aligned with the corresponding passageway 101 at the back row. The passageway 101 spaces the adjacent passageway 101 in the same row at a first, same distance. The slits 103 extend along the mating direction too. Each slit 103 spaces to the corresponding adjacent passageway 101 at a second distance which is smaller than the first distance. The vertical wall 12 has variable, lengthened height for different requirements of customers.

Referring to FIGS. 2-4, the vertical walls 12 of the insulative housing 1 are unsymmetrical relative to an axis of the main portion 10. The vertical walls 12 have different widths. Each vertical wall 12 defines a bottom surface 121 and an inner surface 123 vertical to the bottom surface 121 and abutting the receiving space 103. The vertical wall 12 forms a guiding portion 120 extending from a lower surface of the main portion 10 to the bottom surface 121, generally at middle part of the inner surface 123. The vertical wall 12 further forms a pair of latches 122 at two sides of the guiding portion 120. The insulative housing 1 comprises a bridge portion 102 protruding from the main portion 10 for connecting with the two guiding portions 120.

Referring to FIGS. 2-4, the contacts 2 are assembled to the insulative housing 1 from a lower side thereof. Each contact 2 comprises a base portion 20, a contact portion 21 extending upwardly, curvedly from the base portion 20, a connecting portion 22 extending downwardly from the base portion 20 in a vertical direction perpendicular to the mating direction, a soldering portion 23 bending outwardly from the connecting portion 22, and a pair of wing portions 24 extending upwardly from two edges of the base portion 20 and essentially a little lower than the contact portion 21. The wing portions 24 are received in the slits 103 and therefore, retained with the insulative housing 1. The contact portions 21 extend beyond a top surface of the main portion 10 into the card receiving room for connecting with an inserted card. The connecting portions 22 of the contacts 2 are exposed into the receiving space 13. Each connecting portion 22 has an upper, wider portion 221 connecting to the base portion 20 and a lower, narrower portion 222 connecting to the soldering portion 23.

Referring to FIGS. 1-4, the retaining plate 3 is generally rectangular and the contacts 2 are assembled to the retaining plate 3 from an upper face thereof. The retaining plate 3 comprises a pair of first, opposite edges 30 and a pair of second, opposite edges 32 connecting with the first edges 30. Each first edge 30 defines a plurality of cutouts 33 correspondingly retaining the connecting portions 22 of the contacts 2. The cutouts 33 open to outside and extend along a lengthwise direction perpendicular to both the mating direction and the vertical direction. The connecting portions 22 are assembled into the cutouts 33 of the retaining plate 3 from an upper face thereof and finally retained in the cutouts 33. Each second edge 32 defines a recess 34 at middle part thereof for guiding the guiding portion 120, facilitating attachment of the retaining plate 3 to the insulative housing 1. The guiding portions 120 extend in the recesses 34 and the retaining plate 3 is finally secured to the insulative housing 1 when the latches 122 snap the lower face of the retaining plate 3.

Referring to FIGS. 1-4, the metal cover 4 comprises a flat portion 41 and a pair of lateral walls 42 extending vertically from two edges of the flat portion 41, and a plurality of grounding plates 421 bending inwardly from the lateral walls 42. When the metal cover 4 is assembled on the insulative housing 1, the card receiving room is defined between the main portion 41 and the main portion 10 of the insulative housing 1. The lateral walls 42 secure the vertical walls 12 and the grounding plates 421 are attached to the bottom surface 121 of the insulative housing 1. The grounding plates 421 are soldered with a printed circuit board for grounding purpose.

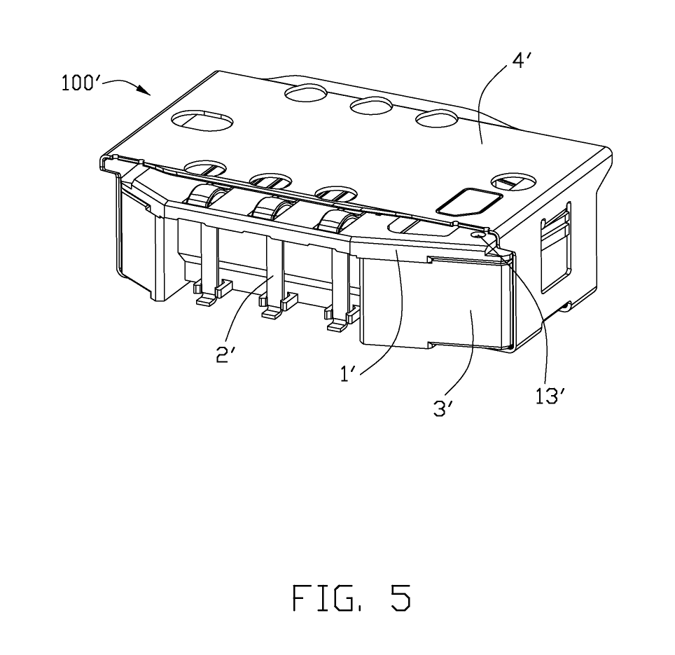

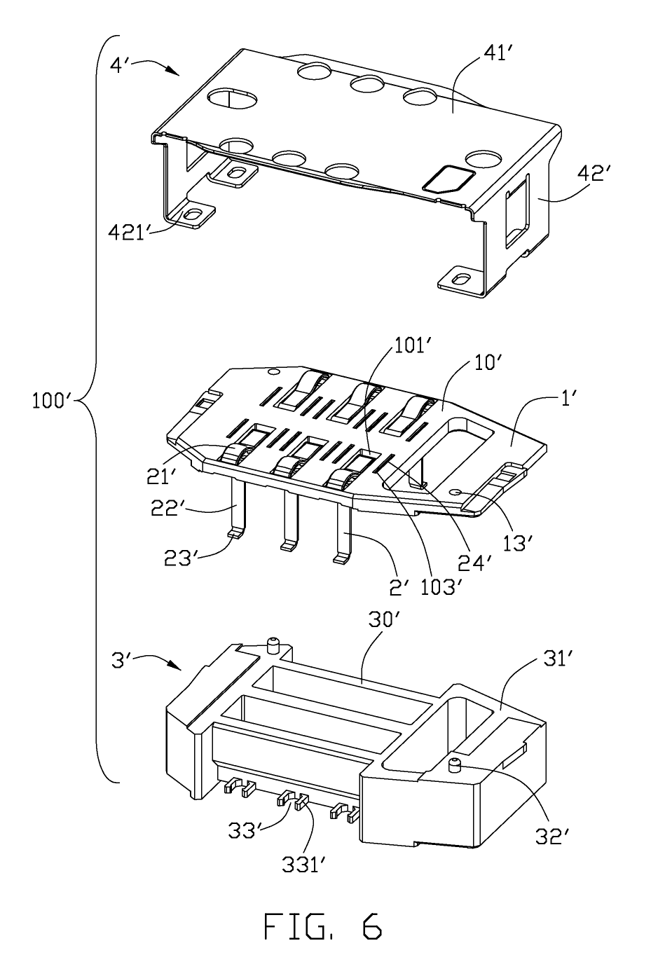

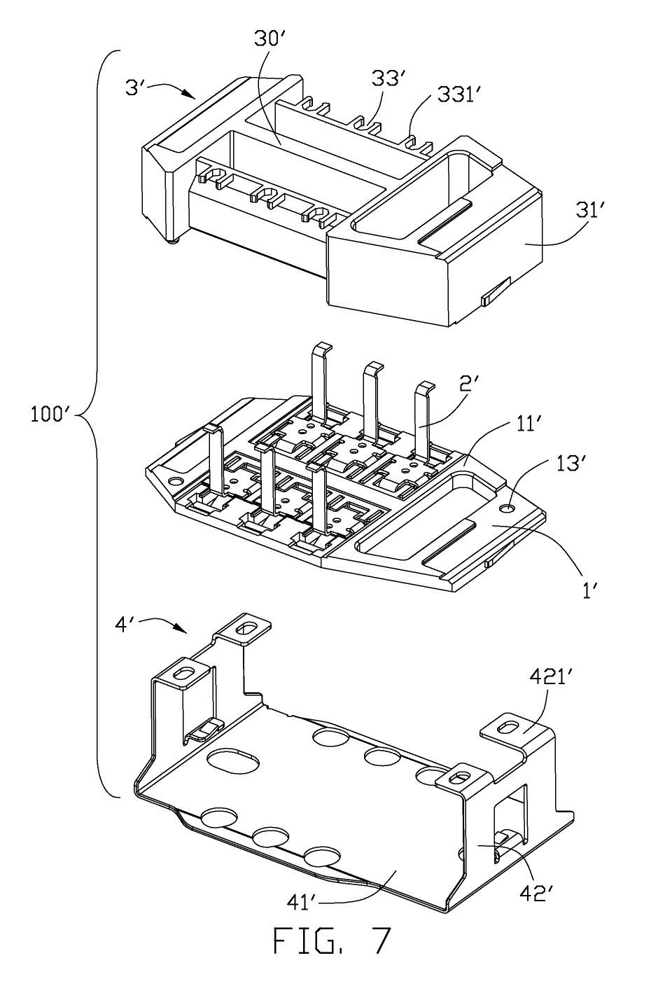

Referring to FIGS. 5-7, the electrical card connector 100′ of the present invention in a second embodiment is shown. The electrical card connector 100′ has an insulative housing 1′, a plurality of contacts 2′ retained in the insulative housing 1′, a retaining plate 3′ attached to the insulative housing 1′ and retaining with the contacts 2′ for preventing the contacts 2′ from shaking leftward and rightward, and a metal cover 4′ shielding over the insulative housing 1′ for defining a card receiving room (not labeled) therebetween. The contacts 2′ and the metal cover 4′ of the second embodiment are respectively same as the contacts 2 and the metal cover 4 of the first embodiment and detail description will not includes therein. The insulative housing 2′ and the retaining plate 3′, which are different from those of the first embodiment, will be described following.

Referring to FIGS. 5-7, the insulative housing 1′ comprises a top surface 10′ facing towards the metal cover 4′ and a bottom surface 11 facing towards the retaining plate 3′. The insulative housing 1′ defines a plurality of passageways 101′ and a pair of slits 103′ besides each passageway 101′. The passageways 101′ extend along a mating direction along which an inserted card is inserted. The passageways 101′ are positioned at two rows along the mating direction with each passageway 101′ at the front row aligned with the corresponding passageway 101′ at the back row. The passageway 101′ spaces the adjacent passageway 101′ in the same row at a first, same distance. The slits 103′ extend along the mating direction too. Each slit 103′ spaces to the corresponding adjacent passageway 101′ at a second distance which is smaller than the first distance. The insulative housing 10′ further defines at least two through holes 13′ unsymmetrical relative to an axis thereof. The insulative housing 10′ has a thin thickness and the contact 2′ comprises a contact portion 21′ extending beyond the top surface 10′ of the insulative housing 2′, a long connecting portion 22′ extending below the insulative housing 22′, a soldering portion 23′ bending from the connecting portion 22′ and a pair of wing portions 24′ retaining in the slits 103′.

Referring to FIGS. 5-7, the retaining plate 3′ has an enlarged height for different requirements of customers. The retaining plate 3′ comprises a main portion 30′ and a pair of end portions 31′ at two ends of the main portion 30′. The main portion 30′ forms a plurality of curved ribs 331′ at two sides thereof. Every two ribs 331′ defines a cutout 33′ for retaining the connecting portion 22′ of the contact 2′. Each end portion 31′ forms a protrusion 32′ protruding therefrom towards the insulative housing 1′. The protrusions 32′ are respectively received and retained in the through holes 13′ and therefore, the retaining plate 3′ is secured to the insulative housing 1′.

In the present invention, because the insulative housing 1 has a pair of vertical walls 12 with variable, lengthened height in the first embodiment, and the retaining plate 3′ attached to the insulative housing 1′ has an variable, enlarged height in the second embodiment, it meets different requirements of customers. Accordingly, the contacts 2, 2′ has elongated connecting portions 22, 22′ firmly retained by the cutouts 33, 33′ of the retaining plates 3, 3′. The connecting portions 22, 22′ are prevented from shaking away from right position. Soldering portions 23, 23′ of the contacts 3, 3′ are coplanar, and the electrical card connectors 100, 100′ are easily soldered with the printed circuit board firmly.

While a preferred embodiment in accordance with the present invention has been shown and described, equivalent modifications and changes known to persons skilled in the art according to the spirit of the present invention are considered within the scope of the present invention as described in the appended claims.

What is claimed is:

1. An electrical card connector comprising:
an insulative housing defining a plurality of passageways and a plurality of slits extending along a mating direction;
a plurality of contacts assembled to the insulative housing from a bottom of the insulative housing, each contact comprising a base portion received in the passageway, a contact portion extending beyond the insulative housing, a connecting portion extending below the insulative housing in a vertical direction perpendicular to the mating direction, and a pair of wing portions retained in the slits; and
a retaining plate associated with the insulative housing, the retaining plate comprising a plurality of cutouts retaining the connecting portions of the contacts from moving in a lengthwise direction orthogonal to the mating direction and the vertical direction; wherein
one of the insulative housing and the retaining plate defines a bottommost surface and the connecting portions of the contacts extend up to the bottommost surface.

2. The electrical card connector as claimed in claim 1, wherein the insulative housing has a length along the lengthwise direction and a width along the mating direction, and the length is dimensioned larger than the width.

3. The electrical card connector as claimed in claim 2, wherein the insulative housing comprises a main portion and a pair of vertical walls extending downwardly from two opposite sides of the main portion, and each vertical wall extends up to the bottommost surface.

4. The electrical card connector as claimed in claim 3, wherein a receiving space is defined between the vertical walls and the retaining plate is received in the receiving space with a lower face thereof located above the bottommost surface.

5. The electrical card connector as claimed in claim 4, wherein each vertical wall defines an inner surface facing the receiving space and forms a guiding portion at the inner surface, and the retaining plate defines a pair of recesses respectively received by the guiding portions.

6. The electrical card connector as claimed in claim 4, wherein the vertical wall forms a plurality of latches at an inner surface thereof and the latches snap the lower face of the retaining plate.

7. The electrical card connector as claimed in claim 6, further comprising a metal cover, and wherein the metal cover comprises a grounding plate attaching to the bottommost surface.

8. The electrical card connector as claimed in claim 2, wherein the retaining plate has a length equal to that of the insulative housing along the lengthwise direction and has a thickness greater than that of the insulative housing along the vertical direction.

9. The electrical card connector as claimed in claim 8, wherein the insulative housing defines a plurality of through holes and the retaining plate comprises a plurality of protrusions retained in the through holes.

10. The electrical card connector as claimed in claim 8, wherein the retaining plate contains the bottommost surface.

11. The electrical card connector as claimed in claim 10, further comprising a metal cover, and wherein the metal cover comprises a grounding plate attaching to the bottommost surface.

12. The electrical card connector as claimed in claim 1, wherein said retaining plate is discrete from and attached to the housing.

13. A high-rise electrical connector comprising:
an insulative housing defining a plurality of contact receiving passageways in a main contact area with a pair of supporting regions by two sides of the main contact area in a lengthwise direction;
a plurality of contacts disposed in the corresponding contact receiving passageways, respectively;
a retaining plate associated with the housing and defining a plurality of tail holding structures which are located around a bottom face of the retaining plate and essentially in alignment with the main contact area in a vertical direction perpendicular to said lengthwise direction; and
a plurality of contacts disposed in the housing, each of said contacts defining a contacting section extending above an upper face of the housing, and a solder tail downwardly extending from the corresponding passageway toward and restrained by corresponding tail holding structure; wherein
a thickness dimension of the main area in the vertical direction is less than one half of a dimension of said solder tail in the vertical direction.

14. The high-rise electrical connector as claimed in claim 13, wherein the pair of the supporting regions extend downward and terminate essentially around a bottom face of the whole connector under condition that said thickness dimension is less than one half of a dimension of the supporting region.

15. The high-rise electrical connector as claimed in claim 14, wherein the retaining plate is dimensioned to be similar to that of the main contact area in the lengthwise direction.

16. The high-rise electrical connector as claimed in claim 13, wherein the whole housing keeps essentially a similar thickness in the lengthwise direction.

17. The high-rise electrical connector as claimed in claim 16, wherein the whole retaining plate keeps essentially a similar thickness in the lengthwise direction.

18. The high-rise electrical connector as claimed in claim 13, further including a metallic shell assembled to at least one of the housing and the retaining plate with solder pads located around a mounting face of the whole connector and under said pair of supporting regions in the vertical direction.

19. A high-rise electrical connector comprising:
an insulative housing defining a plurality of contact receiving passageways in a main contact area with a pair of supporting regions by two sides of the main contact area in a lengthwise direction;
a plurality of contacts disposed in the corresponding contact receiving passageways, respectively;
a retaining plate associated with the housing and defining a plurality of tail holding structures which are located around a bottom face of the retaining plate and essentially in alignment with the main contact area in a vertical direction perpendicular to said lengthwise direction; and
a plurality of contacts disposed in the housing, each of said contacts defining a contacting section extending above an upper face of the housing, and a solder tail downwardly extending from the corresponding passageway toward and restrained by corresponding tail holding structure; wherein
each of the tail holding structures retains the corresponding solder tail in both said vertical direction and a transverse direction which is perpendicular to both said vertical direction and said lengthwise direction.

20. The high-rise electrical connector as claimed in claim 19, wherein said retaining plate is moved to a mid-level of the while connector when said retaining plate is fully assembled to the housing.
